(19) United States
(12) Patent Application Publication
(10) Pub. No.: US 2007/0100617 A1
(43) Pub. Date: May 3, 2007

(54) Text Microphone

(75) Inventor: Rita Singh, Watertown, MA (US)

Correspondence Address: HAIKYA CORP., 9 CHAUNCEY ST., WATERTOWN, MA, 02472, US

(73) Assignee: HAIKYA CORP., Watertown, MA (US)

(21) Appl. No.: 11/163,861

(22) Filed: Nov. 1, 2005

(51) Int. Cl. G10L 15/26

(52) U.S. Cl. 704/235

(57) ABSTRACT

A microphone that transduces incident pressure waves (e.g. those representing sounds) and generates text streams as a response. The microphone is a single, integrated unit with device specifications that apply to the entire unit.

### FIELDS OF INVENTION

This invention relates to hardware devices for audio processing, and more particularly to microphones.

### BACKGROUND OF THE INVENTION

Microphones have been used for decades to capture audio signals from their immediate environment, and to make them available in analog or digital form to other devices for direct amplification and broadcast, or storage. The function of the microphone in this context has been to sense incoming pressure waves and convert them to an analog or digital electrical signal that represents a waveform, for further processing. Historically, any microphone has been devised to optimally transduce incoming pressure waves to electrical signals with as high fidelity as possible given specific constraints and requirements, including economic ones.

Microphones have been covered by hundreds of patents, all of which, without exception, relate to the quality and fidelity with which the incident pressure wave is converted to an electrical signal and the transduced electrical signal is made available to external devices.

It is desired to create microphones that transduce incoming pressure waves directly to text, with specifications that relate to the quality and fidelity of the text.

### SUMMARY OF THE INVENTION

The invention includes the concept of using a microphone to output or make available text rather than waveforms.

To understand this invention in an unambiguous manner, it is crucial to define a microphone precisely. A microphone, as must be understood in this document and in relation to this invention, is a device that responds to incoming pressure waves by generating a time-varying electrical signal, to be presented either in analog or digital form to external devices. The prior art in microphones relates exclusively to devices whose output is a waveform, either in analog or digital form. Although these devices may contain significant internal circuitry, the purpose of this circuitry is to enhance, denoise, or otherwise modify the electrical waveform captured by the microphone. The eventual purpose of the microphone is always the single task of presenting this captured waveform to external devices.

The invention described in this document, however, transduces incoming pressure waves directly into comprehensible language text (e.g. a string of English words) that is presented to external programs or devices. In order to accomplish this functionality the microphone incorporates internal circuitry that converts the signals generated from sensing the incoming pressure waves to a human-readable language. This circuitry could take various forms, including ASIC processors, analog VLSI circuitry or circuit board incorporating conventional processors, incorporating classification or recognition firmware.

The text transduced by the microphone is then appropriately encoded and transferred to any external computing device that can use correctly a software driver program that helps the device to interface correctly with the Text Microphone. The invention does not, however, include the specific drivers that may be used to read the text data output by the microphone, such drivers being specific to the operating system and application that uses the text microphone.

Similarly to conventional microphones, the text microphone may be constructed to specification. For example, a particular Text Microphone may be constructed to optimally transducer speech generated by a female human child in an automobile. Thus, a user may build, obtain or purchase a text microphone for a set of specifications that they stipulate. Thus, the specifications for a Text Microphone used to transducer speech may include the following: gender of user for which the microphone works, language, nativity and accent of user, operating environment in which it will be used, etc. On the other hand, a Text Microphone meant to transduce other audio signals may be specified by the kind of sounds it must transduce, such as sounds in a battle field.

### BRIEF DESCRIPTION OF THE DRAWINGS

FIG. 1 is a block diagram of the invention; and

FIG. 2 is a block diagram of one embodiment of the invention.

### DETAILED DESCRIPTION OF THE PREFERRED EMBODIMENT

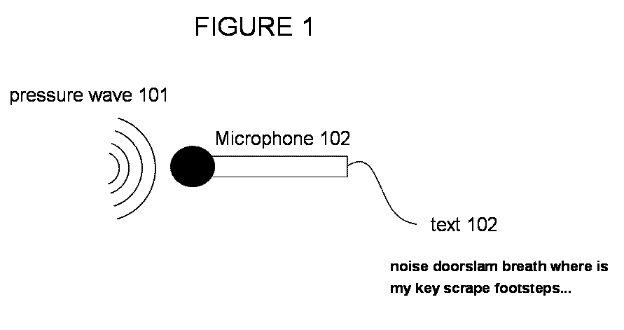

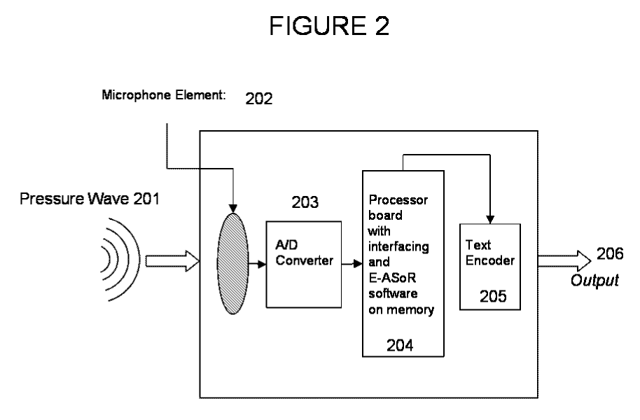

System Structure
FIG. 1 shows a Microphone (102) that senses incoming pressure waves (101) and outputs text strings (103). The text string is a faithful and precise (to the extent possible based on the current state-of-art in the related technology) hypothesis of the sounds underlying the pressure waves captured by the microphone. Although this is predominantly expected to be human speech, the hypothesis is not confined to human speech. It includes all sounds, atomized and described by text in some manner, such as the example string shown in FIG. 1.
FIG. 2 shows how the invention may be embodied based on current and existing scientific know-how in the related fields. The diagram shows the internal structure of a Text Microphone:
The incoming pressure wave (201) is incident on a microphone element (202) and is captured as an analog electrical waveform by the element. This analog signal is sent to an analog-to-digital (A/D) converter (203) and is digitized by this element. The A/D converter interfaces through an appropriate protocol with a processor board (204) that uses a standard operating system such as embedded Linux to function. The processor board has a memory module that is sufficient to hold an Automatic Sound Recognition (ASoR) systems. An ASoR system can, for example, be a modified version of a voice recognition system that is traditionally used in various software applications (such as dictation systems) to perform speech recognition. The ASoR system generates strings of text in a particular format most suited to the processor board capabilities. This text is then fed into a Text encoder (205), that encodes it in a format suitable for electronic transfer to external systems or devices that can store, display or process the text (e.g, a standard desktop computer that takes in text through the keyboard, a telephone or fax that display and processes a number or message, etc.). Extending the technical notations used for such systems in the scientific literature, we will call the particular variety of ASoR systems that are embedded in the memory of the processor board in the Text Microphone as an Embedded-ASoR or E-ASoR system.

What is claimed is:

1. The concept of a microphone that outputs text instead of waveforms.

2. The method of claim 1 further comprising conformance to microphone specifications that include particulars of human gender, language, accent, dialect, nativity, age and all other factors that affect the sounds generated by a human vocal tract.

3. The method of claim 1, in which the signal underlying the pressure waves sensed by the microphone is not confined to human speech, but extends to all possible sounds.
